(19) United States
(12) Patent Application Publication
(10) Pub. No.: US 2026/0118581 A1
(43) Pub. Date: Apr. 30, 2026

(54) PHOTONICS INTEGRATED CIRCUIT (PIC) DEVICE, METHOD OF OPERATING A PIC DEVICE, AND PIC CHIP THEREFOR

(71) Applicants: Nikolay VIDENOV, Waterloo (CA); Michal BAJCSY, Waterloo (CA)

(72) Inventors: Nikolay VIDENOV, Waterloo (CA); Michal BAJCSY, Waterloo (CA)

(21) Appl. No.: 19/367,906

(22) Filed: Oct. 24, 2025

Related U.S. Application Data
(60) Provisional application No. 63/711,759, filed on Oct. 25, 2024.

(51) Int. Cl. G02B 6/122; G02B 6/10; G02B 6/12; G02B 6/125

(52) U.S. Cl. CPC G02B 6/1223; G02B 6/102; G02B 6/12002; G02B 6/125; G02B 2006/1204; G02B 2006/12142

(57) ABSTRACT

The PIC device can have a PIC chip having one or more superposed layers including a tuning circuit layer, the one or more superposed layers including a waveguide for electromagnetic radiation, the waveguide being made of non-centrosymmetric crystalline material having a non-zero Pockels coefficient; the tuning circuit layer having an electrical circuit including a resistance thermally coupled to the waveguide, and an electrode capacitively coupled to the waveguide, a current source connected to the resistance; a voltage source connected to the electrode; and a controller operable to control the current source and the voltage source in a manner to perform tuning to the waveguide.

### BACKGROUND

Photonics on chip is an enabling technology for commercialization and scaling in a number of key fields. Photonics on chip typically involves a waveguide for electromagnetic radiation (referred to as photons at the discrete level) incorporated to the layered structure of a “chip”. Various materials have been used for such waveguides, and the choice of a given material for a given application can depend on a number of factors, namely the energy level (wavelength, frequency) of the electromagnetic radiation to be guided (e.g., infrared or visible regions of the electromagnetic spectrum). Moreover, in many cases, some form of tuning ability for the electromagnetic radiation propagation is incorporated to the devices, and the choice of material for the waveguide may further be guided by the tuning approach. PIC devices which incorporate tuning may be referred to as modulators. Various applications may use modulators, such as quantum sensing, augmented reality displays, and biological systems.

When selecting a modulator for a given embodiment, various factors may be taken into consideration. Such factors include costs and reliability, but also additional factors such as tuning range and modulation bandwidth speed. While existing approaches to modulators were satisfactory to a certain degree, there always remains room for improvement, such as increasing either tuning range, speed of modulation bandwidth, or both, for a given bandwidth of operation of the electromagnetic radiation, and this need may be greater for certain bandwidth of operation of the electromagnetic radiation, such as the visible portion of the electromagnetic spectrum for instance.

### SUMMARY

In accordance with one aspect, there is provided a photonic integrated circuit (PIC) device comprising: a PIC chip having one or more superposed layers including a tuning circuit layer, the one or more superposed layers including a waveguide for electromagnetic radiation, the waveguide being made of non-centrosymmetric crystalline material having a non-zero Pockels coefficient along one or more electro-optically active crystal axis, the tuning circuit layer having an electrical circuit including a resistance thermally coupled to the waveguide, and an electrode capacitively coupled to the waveguide; a current source connected to the resistance; a voltage source connected to the electrode; and a controller operable to control the current source in a manner to perform thermo-optic phase tuning to the waveguide via variations in resistive heating of the resistance, and control the voltage source in a manner to perform electro-optic phase tuning to the waveguide via variations in electric field generated at the electrode and a Pockels effect associated to the non-zero Pockels coefficient.

In accordance with another aspect, there is provided a method of operating a photonic integrated circuit (PIC) device including: propagating electromagnetic radiation in a waveguide made of a non-centrosymmetric crystalline material having a non-zero Pockels coefficient along an electro-optically active crystal axis controlling the phase of the electromagnetic radiation including: circulating a current through a resistance which is thermally coupled to the waveguide, and applying an electrical field at the waveguide, along the electro-optically active crystal axis.

In accordance with another aspect, there is provided a photonics integrated circuit (PIC) chip comprising: one or more superposed layers including a waveguide for electromagnetic radiation, the waveguide being made of non-centrosymmetric crystalline material having a non-zero Pockels coefficient; a tuning circuit layer having an electrical circuit including a resistance thermally coupled to the waveguide, and an electrode capacitively coupled to the waveguide

Many further features and combinations thereof concerning the present improvements will appear to those skilled in the art following a reading of the instant disclosure.

### DESCRIPTION OF THE FIGURES

In the figures,

FIG. 1 is a schematic view of an example of a photonic integrated (PIC) device;

FIGS. 2A and 2B are schematic top plan, and cross-sectional views, respectively, of an example embodiment of a PIC chip;

FIGS. 3A and 3B are schematic top plan, and cross-sectional views, respectively, of another example embodiment of a PIC chip;

FIG. 4 a) Primary fabrication steps for waveguides and electrodes. b) Insert shows the relation between the crystal axis, polarization axis, and device axis. Plot shows the electric field norm for 1 V applied to the central electrode. c) Conceptual diagram of ring resonator and dual-mode tuner. d) Fabricated chip in testing fixture. On the left is a fibre array which is used to route optical signals in-to and out-of the chip. The global chip temperature is stabilized by feedback from the pictured temperature probe through controlling the temperature of the aluminum support block. The mounting printed circuit board (PCB) has a thermal pad with through vias for transferring heat from the support block to the chip.

FIG. 5 a) Temperature sensitivity of a 5 mm circumference racetrack micro-ring resonator. Temperature was adjusted by setting the temperature on the support block for the PIC chip. d) Transmission peak location plotted against temperature showing a 12 pm/C linear slope. b) Example electro-optic (EO) tuning data for the 0.202 pm/V data point. e) EO tuning for both TE and TM modes. Central electrode width was varied to control for simulation and experimental inconsistencies. Each datapoint has a corresponding curve like that shown in b). c) Full voltage swing applied in transverse direction in an attempt to excite the r51 EO coefficient. f) TE and g) TM modes as calculated using Lumerical MODE. The electric field fill factors are 0.781202 and 0.715527. TE is polarized horizontally (perpendicular to the AlN c-axis which is vertical) as is convention. The calculated effective group index is 2.104481 and 2.103834. The index used in the calculation is determined through fitting to ellipsometric accounting for bi-refringence (woolman ellipsometer and complete ease software). The measured effective group index is 2.10 for the TE and 2.18 for the TM.

FIG. 6 a) Temperature modulation. The settling time is in excess of 100 ms; even a 10 Hz square wave is not faithfully reproduced. b) 12 Mbps eye diagram taken using a dual-mode tuner in a purely EO mode. The pictured data was taken through a 20 MHz low pass filter to reduce ringing.

FIG. 7A is a block diagram of split control scheme. The FPGA used was an ICE40-HX8K on a consumer breakout board.

FIG. 7B is a schematic diagram of a sample split control scheme. Current is controlled through a P-type mosfet. Voltage control is achieved depending on application. Pictured here, on the top, a PDu100B piezo controller for large Pockels tuning range but poor bandwidth, or on the bottom, through a 1EDN8550B gate driver for MHz on-off switching. A third configuration not pictured is to use an appropriate radio frequency circuit to achieve arbitrary high Pockels voltage setpoint at a high bandwidth.

FIG. 8 Signal transmission in a thermally unstable environment. a) Thermally stabilized with dual-mode tuner. Eye diagrams shown as inserts with consistent appearance. b) EO only used for data transmission. For ease of reading the error free operating range with comparable performance to the dual-mode tuner is shaded in blue, while inferior performance is shaded in red. Eye diagrams show the range of achieved contrasts.

FIG. 9 a) Split control correcting for a 3 C change in global temperature. Thermal tuning range is exhausted before EO tuning range is engaged. When overshoot of global temperature lock is corrected the EO returns to its midpoint. b) Split control responding to mechanical tapping on testing station. The full scale of the EO tuning is required to correct for the disturbance which is only possible with the thermal correction.

### DETAILED DESCRIPTION

Let us begin by addressing an example case of visible wavelength photonics. Waveguide materials for visible wavelength photonics include silicon nitride (SiNx) and lithium niobate (LiNbO3), which both have a 4 eV (310 nm) band gap. However, these materials are limited by their two-photon absorption boundary (620 nm) when used for high power applications such as laser cavities or nonlinear optics, and by their direct band gap when considering UV photonics. Alternate materials which may be suitable for UV-visible wavelength photonics include aluminum oxide (Al2O3) with a 7 eV (180 nm) band gap and aluminum nitride (AlN) with a 6 eV (200 nm) band gap. Of these possibilities, when considering an electro-optic modulator embodiment, AlN may remain favored for a high index (2.2), large band gap, and electro-optically (EO) active material. While the EO coefficient is non-zero, it is modest. Compared to the other material choices, the required applied voltage for the same index change and length is an order of magnitude larger, which may limit tuning range.

Indeed, the latter issue may be further exacerbated by the requirement for the applied voltage to be parallel with the crystal c-axis, in the specific case of AlN. This is almost exclusively normal to the wafer. This may be achieved by embedding electrodes in a parallel plate capacitor configuration or by using a three-electrode configuration to produce an out-of-plane field. The latter approach may be less efficient for the same applied voltage because the waveguide mainly sees stray field rather than the field between the electrodes.

Thermo-optic (TO) tuning offers an alternative for controlling integrated photonic components, especially for materials with vanishingly small EO coefficient like SiNx. In such materials TO tuners can achieve kHz modulation bandwidth. The TO coefficient for AlN can be (1.2±0.3)×10\hat{ }(−5)/C, which is in the same order of magnitude as most other optical materials. As a result thermal tuning of AlN photonic structures is a suitable approach for large index changes.

Accordingly, in some materials electro-optic tuning and thermo-optic tuning may have distinct advantages and inconveniences. Offering the possibility of integrating both types of tuning may thus constitute a significant interest, but PIC chips are confined environments formed of layered structures which inherently limit the possibilities. It was found that integrating both types of tuning in a same nanofabrication layer was not only possible, but also feasible. A device integrating two, or more, of such modes in a single layer can be referred to herein as a dual-mode tuner for ease of reference.

Some example materials will be explicitly mentioned below, though it will be understood that other materials offering suitable properties for use as a dual-mode tuner may exist, or be discovered over time. In visible photonics applications, for instance, an example material is AlN. Materials may be used undoped or may be doped to improve their properties in view of a particular application. For instance, Al(Sc)N, i.e., AlN with Sc dopant, can be particularly suitable as it can have a larger EO coefficient than AlN. Moreover, another example material which can be suitable is LiNbO3. Different use cases may benefit differently from different materials.

Indeed, in some embodiments, a photonic modulator can implement either electro-optic or thermo-optic tuning, each requiring separate fabrication layers or trade-offs between bandwidth and tuning range. In some other embodiments, examples of which will be described below, a dual-mode configuration can be achieved, integrating both effects within a single nanofabrication layer. This can allow to eliminate additional lithography steps while enabling simultaneous or sequential operation.

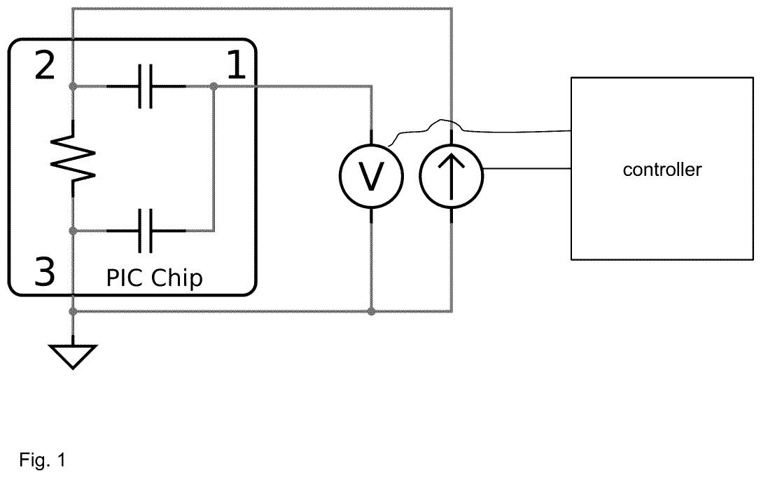

Referring to FIG. 1, it was found that an electrical circuit could be formed in a layer of the PIC chip. This layer, which can be referred to as the tuning circuit layer, can be the same layer as the waveguide, or an adjacent layer, depending on the embodiment, as will be exemplified below. The electrical circuit can include a resistance through which current can be circulated via a current source, and an electrode to which a voltage can be applied by a voltage source. The resistance can be said to be “thermally coupled” to the waveguide in the sense that temperature variations caused by changes in current circulation through the resistance can, relatively directly, impart temperature variations in the waveguide. The waveguide can be made of a non-centrosymmetric crystalline material, i.e., a material having a non-zero Pockels coefficient along one or more electro-optically active crystal axis. The electrode can be said to be capacitively coupled to the waveguide in the sense that it can generate an electric field which extends across the waveguide. The electrical circuit is electrically insulated from the waveguide.

Both effects can be independently produced by running a current through the resistance to induce resistive heating, while applying a voltage to the electrode to produce an electro-optic effect. When the resistance is small, the overall voltage drop may be considered to lead to small EO voltages, independent of the current set-point. Conversely the small capacitance of the device can make the temperature unaffected by voltage set-point.

The controller may be embodied as a computer, one or more other electronic device, or a combination thereof.

The Pockels effect is in principle described by a tensor, and in theory, there can exist a crystal for which any electric field direction can change the refractive index in any other direction. Some materials may have a single electro-optically active crystal axis along which the Pockels effect may be activated, whereas other materials may exhibit more than one electro-optically active crystal axes which can have a same or different Pockels coefficients. Many materials do not exhibit any significant electro-optically active crystal axes. In the specific case of AlN, there is a single crystal axis along which an applied electric field causes a Pockels effect, which we call the electro-optically active crystal axis, or the c-axis. Other axes, which can be referred to as the a or b axes, may not exhibit significant Pockels coefficients. In the case of LiNbO3, all three axes, which may be referred to as the a, b, and c axes, may exhibit significant Pockels coefficients. Indeed, the Pockels (or electro-optical-EO) coefficients can vary from 3.4 pm/V to 32 pm/V, which can be considered significant, and there may be embodiments where it may be preferred to apply an electric field along the a or b axis rather than the c axis. Different non-centrosymmetric crystals may have different relevant axis labels.

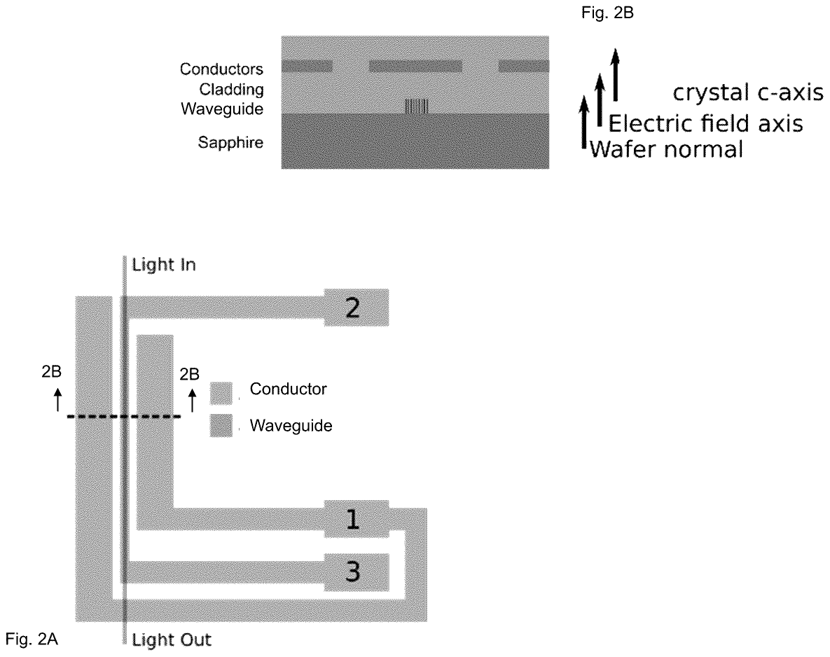

FIGS. 2A and 2B present an example embodiment which may be suitable for a PIC chip with a waveguide made of Aluminum nitride (AlN) for instance. In this example, the PIC chip has several superposed layers stacked in the orientation normal to the wafer plane. The “tuning” electrical circuit is integrated to a layer which is a different layer than the one in which the waveguide is integrated. In this example, the electrical circuit is in a layer which is disposed above the waveguide layer. Three elongated conductors are used as illustrated in FIG. 2A, including a thinner elongated conductor acting as a resistance, disposed between two broader, elongated conductors acting as electrodes or capacitor plates. The resistance is disposed parallel to the waveguide, and above the waveguide, promoting proximity of the waveguide to the source of heat/thermal tuning. The electro-optically active crystal axis (specifically the c-axis in this specific case) of the waveguide is disposed parallel to the wafer normal. The electrodes generate an electric field extending parallel to the electro-optically active crystal axis and to the wafer normal at the waveguide in a manner that, when a voltage is applied at the electrodes, variations in the electric field impart variations in phase tuning of the electromagnetic radiation circulating in the waveguide due to the Pockels effect (the non-zero Pockels coefficient of the waveguide). In the illustrated embodiment, a current source can be connected to wire bonding pads 2 or 3 (the other may be grounded or otherwise maintained at a fixed voltage) to push current through the resistance and produce resistive heating, and a voltage source can be connected to wire bonding pad 1, and the control voltage applied to the two elongated conductors disposed astride the resistor produces Pockels effect tuning. More specifically, the three conductors are above the waveguide and produce a field along an electro-optically active crystal c. This is the growth axis of the waveguide and is orthogonal (normal) to the wafer. In this case three conductors are used, and vertical distance can be provided between the conductors and the waveguide to avoid absorption losses.

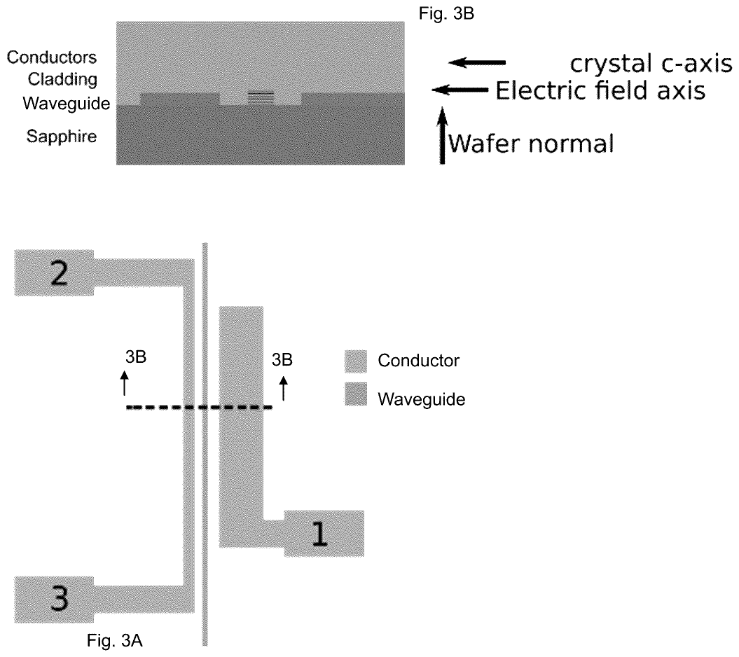

FIGS. 3A and 3B present an example embodiment which may be suitable for a PIC chip with a waveguide made of Aluminum nitride (AlN) or of lithium niobate (LiNbO3) for instance. In the case of lithium niobite, there is a greater variety of available cut axis (variety of relative orientations between wafer axis and crystal axis), the most popular configuration has the critical crystal axis positioned horizontally, in plane with the wafer such as shown in FIG. 3B. For LiNbO3 the critical axis is the c-axis. When the crystal c-axis is horizontal, the electric field may also be applied horizontally along the plane of the wafer, which can be done with two elongated conductors instead of three. In this case, the electrodes can be in plane with the waveguides, or above the waveguides or otherwise said, they can be included in the same layer as the waveguide, or in an adjacent layer. The electric field may be stronger in the scenario where the electrodes are in plane with the waveguide, or in the same layer, which is the scenario which is illustrated in FIG. 3B.

Two elongated conductors are used as illustrated in FIG. 3A, including a thinner elongated conductor acting as a resistance, disposed alongside a broader, elongated conductors acting as an electrode or a capacitor plate. The resistance is disposed adjacent to the waveguide, promoting proximity of the waveguide to the source of heat/thermal tuning. An electro-optically active crystal axis of the waveguide, such as the c-axis for instance, is disposed parallel to the wafer plane. The electrodes generate an electric field extending parallel to the electro-optically active crystal axis and to the wafer plane at the waveguide in a manner that, when a voltage is applied at the electrodes, variations in the electric field impart variations in phase tuning of the electromagnetic radiation circulating in the waveguide due to the Pockels effect (the non-zero Pockels coefficient of the waveguide).

In the illustrated embodiment, a current source can be connected to wire bonding pads 2 or 3 (the other may be grounded or otherwise maintained at a fixed voltage) to push current through the resistance and produce resistive heating, and a voltage source can be connected to wire bonding pad 1, and the control voltage applied to the corresponding elongated conductor produces Pockels effect tuning. More specifically, the two conductors are astride the waveguide and produce a field along the crystal c-axis.

In the different scenarios presented above, both thermo-optic and Pockels tuning may be applied to the waveguide and may even be applied simultaneously. This tuning is applied via a tuning electrical circuit which can be integrated to a single fabrication layer. Such an approach can have benefits. Firstly, each nanofabrication step in the cleanroom is expensive. By including both types of tuning into the same fabrication layer there is no increased nanofabrication cost. Secondly, both thermo-optic tuning and Pockels effect tuning performs best when the control electrodes are as close as possible to the waveguides. If the corresponding circuits are integrated to different layers, there can be a trade-off in choosing which one should be closer. This is not the case when both circuit elements are integrated to a same layer. Thirdly, if both types of tuning can be implemented for the same cost, then there is significant benefit in having two types of tuning. By having an additional control knob more sophisticated control schemes can be realized. Two example cases are presented below where the “dual-mode tuner” outperforms either only Pockels effect or only thermo-optic effect tuning.

The Pockels effect, which is only present in non-centrosymmetric crystalline materials, is highly sought-after in photonic integrated circuits. This effect is a linear change in optical phase due to a change in applied voltage which can be used to switch optical signals at GHz bandwidth, low power consumption compared to alternative effects and is straightforwardly implemented by being linear with voltage. Unfortunately, few materials have a non-zero Pockels coefficient, fewer still have a Pockels coefficient of notable magnitude.

Aluminum nitride (AlN) is remarkable in that it has both a Pockels effect and a large band gap. The latter is required for visible to ultraviolet photonics, since the band gap will determine how short a wavelength can be transmitted without excess absorption. While the Pockels coefficient in AlN is non-zero, the coefficient is modest in magnitude and either long waveguides or high voltages (or both) may be needed to achieve suitable phase change (V_{π}L_{π}>200 Vcm).

For many materials there is the possibility of implementing thermo-optic tuning; a change in refractive index due to a change in temperature. Many materials have a similar magnitude thermo-optic coefficient, which is sufficient to achieve qualitatively “large” tuning ranges. However thermo-optic tuning is known to be slow (kHz). This is limited by the time it takes for the temperature change to equalize across the waveguide. In the example presented above in FIGS. 2A and 2B, the thermo-optic index change per mA (of current) can be about 10× larger than the Pockels effect per V.

Embodiments such as presented above can be used on electromagnetic radiation in the range of visible wavelength photonics as a whole. In the case of embodiments using AlN for the material of the waveguide, such embodiments may be used on electromagnetic radiation in the range of visible wavelength photonics and/or UV wavelength photonics. The Pockels effect can be used for fast modulation and the thermo-optic effect can be used for tuning range. The Pockels effect and the free carrier effect are types of electro-optic effects.

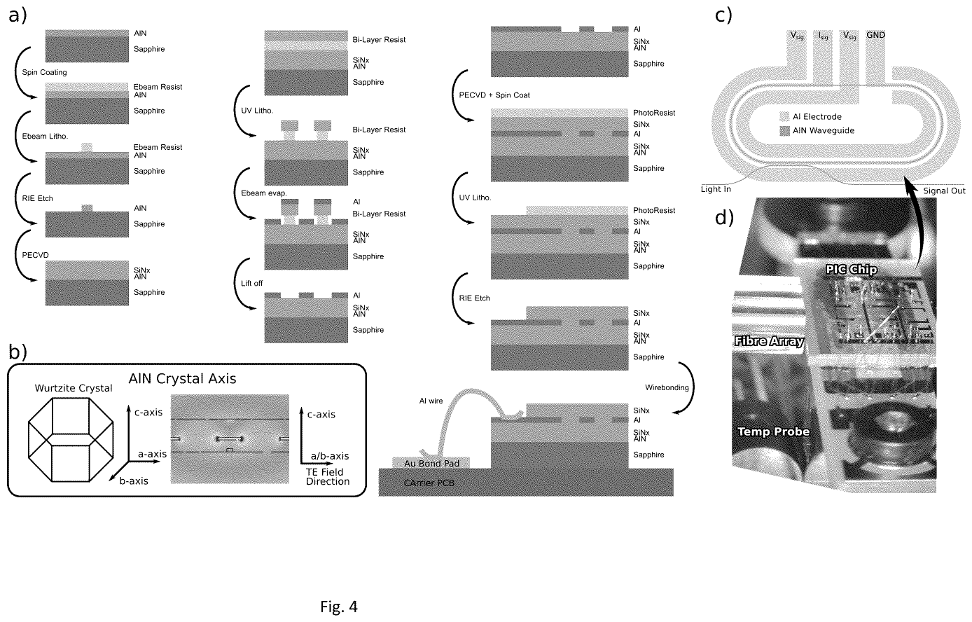

A detailed example will now be presented in relation with FIG. 4 and following.

The electrodes were fabricated by lift-off, shown in FIG. 4a). A bi-layer resist was patterned using 405 nm radiation from a Heidelberg MLA150 mask-less aligner. 300 nm of aluminum metal was deposited with an Angstrom Amod electron beam deposition system. The electrode thickness was limited by the bi-layer resist to a maximum of 300 nm. To support high magnitude electric fields the electrodes were clad with SiNx and a further lithography step was done to open wire-bonding pads. The chip and support PCB were electrically connected by 25 μm diameter aluminum wire bonds.

The home-built testing apparatus is partially shown in FIG. 4d) and consists of two 6-axis Thorlabs NanoMax translation stages which stand a-stride a generic three axis stage. The devices were adhered to a carrier PCB with Crystalbond 509, and the electrical connections to the PCB were made with an edge card connector. The PCB was bolted to the three-axis stage onto a thermally controlled aluminum block.

In this example, while aluminum was used for the electrodes and SiNx for the dielectric cladding in the embodiments described, it will be understood that alternate materials and processes may be used in other embodiments. In particular, other conductive materials such as titanium, platinum, gold, tungsten, copper, or transparent conductive oxides (e.g., indium tin oxide, ITO) may be employed for the electrodes, and dielectric claddings such as SiO₂, Al₂O₃, or HfO₂ may substitute for SiNx. Similarly, alternative nanofabrication methods including sputtering, atomic-layer deposition, or plasma-enhanced chemical vapor deposition (PECVD) may be used and may lead to comparable structural and optical characteristics.

Light was coupled in-to and collected out-of the chip with an 8-channel fibre array from oz-optics. The outermost two channels of the fibre array are multi-mode while the remaining channels are polarization maintaining single mode fibre. A Toptica DL pro 100 laser operating around 852 nm was used in these tests.

Embodiments of tested micro-ring resonator referred to explicitly herein had a circumference of roughly 5 mm. The electrodes varied in center electrode width and inter-electrode gap. The smallest of both was 3 μm. Other waveguide geometries and sizes may be used in alternate embodiments. While smaller features are possible with further recipe optimization, lateral alignment of the waveguides to the electrodes can reach a significant relevance as the two approach the same width.

A micro-ring resonator has a transmission dip when the optical path length (nL) of one round trip is an integer (q) multiple of the wavelength (λ); nL=λq. The dip occurs at

$$λ = \frac{L}{q} n .$$

In this section the change in dip position is related to the change in refractive index by

$$\partial λ = \frac{L}{q} \partial n .$$

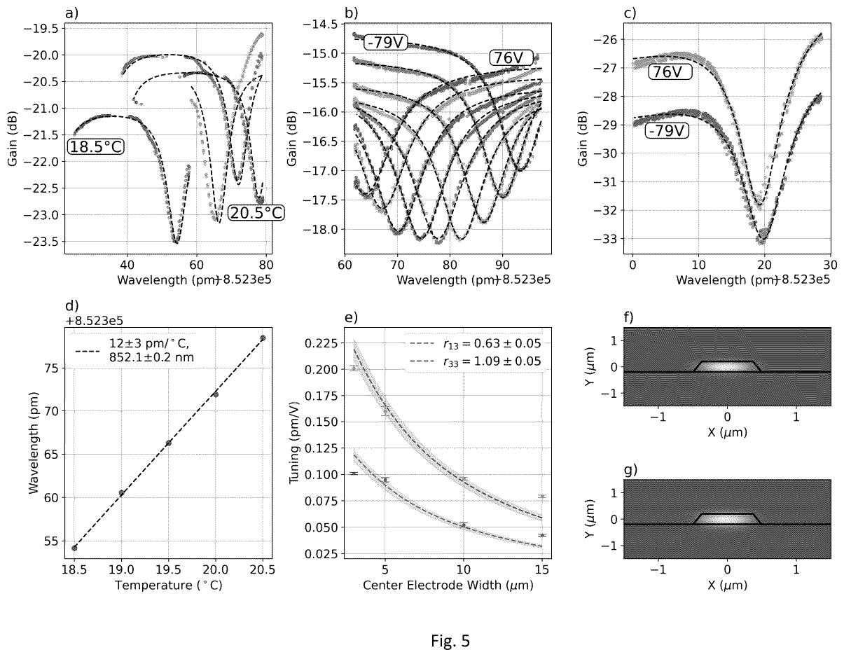

The thermo-optic effect changes the refractive index by nT≈n₀α₁ where α₁ is the first thermo-optic coefficient. We assume the temperature change uniform over the whole waveguide. The electro-optic effect likewise changes the refractive index by

$$\frac{\partial n}{\partial V} \approx - \frac{1}{2} {n}_{0}^{3} {r}_{xx} γβ V$$

where V is the applied voltage, n₀ is unperturbed refractive index, and rₓₓ is the electro-optic coefficient. γ is a geometric factor which relates the applied voltage on the electrodes to an electric field strength which is determined by the shape of the electrodes. The units of γ are 1/m and the value is determined by COMSOL simulation; partially shown in FIG. 4 b). β accounts for the overlap between the optical mode and the AlN waveguide; any light outside the AlN will not see an index change, and is calculated using Lumerical MODE as shown in FIG. 5 f).

The slope of FIG. 5 a) is related to the thermo-optic coefficient by

$$λ T = λ nnT = \frac{{Ln}_{0} {α}_{1}}{q} , \qquad ( 1 )$$

and in the same way the slope of FIG. 5 b) is λV which is related to the electro-optic coefficient by

$$λ V = λ nnV = - \frac{{Ln}_{0}^{3} {r}_{xx} αβ}{2 q} . \qquad ( 2 )$$

Solving for the thermal coefficient yields α₁=(1.2±0.3)×10⁻⁵/C. This agrees with literature values, and is in reality a lower bound on the coefficient. The thermal coupling between the thermally controlled support block and the PIC chip itself is not perfect and convective cooling from the surface of the PIC will lower the true temperature at the resonator.

Similar analysis was applied to the electro-optic effect to find that the electro-optic coefficients are r₃₃=1.09±0.05 pm/V and r₁₃=0.63±0.05 pm/V. These values were found by fabricating a series of identical 5 mm racetrack resonators with varying middle electrode width. This was done to verify the COMSOL electric field simulation. Narrowing the middle electrode increases the geometric factor in Equation 2 producing a larger change for the same applied voltage, as seen in FIG. 5 e). At 3 μm central electrode width the trace resistance of the electrode and the lateral alignment between the waveguide and the electrodes become important. Hence a reduction in the observed tuning compared to simulation. The ratio between the TE and TM tuning remains constantly 0.58 through all electrode widths. The ratio is only dependent on the EO coefficients; it is a more robust observation.

These values are within the range of literature values, though previous authors have reported inconsistent findings. The consensus seems to be between 0.1 pm/V and 1.2 pm/V with ambiguity in which coefficient is larger, the sign of the coefficient, and the exact value of the coefficients. Some of the ambiguity might come from the method of film preparation and the difference between bulk and thin film AlN. For this study the TE polarization is perpendicular to the c-axis in the AlN film.

Consistent with all previous studies the r₅₁ coefficient is below the measurement threshold (<0.05 pm/V). As shown in FIG. 5 c) the transmission curve does not show any appreciable movement when applying a 180 V difference. Some movement in the transmission peak was observed when probing for the r₅₁ coefficient, we believe this movement was consistent with elasto-optic tuning from piezo-electric stress in the waveguides rather than from the EO coefficient, although not thoroughly investigated as the effect was at the detection threshold. Additionally this tuning was symmetric about 0 V while EO tuning must be linear.

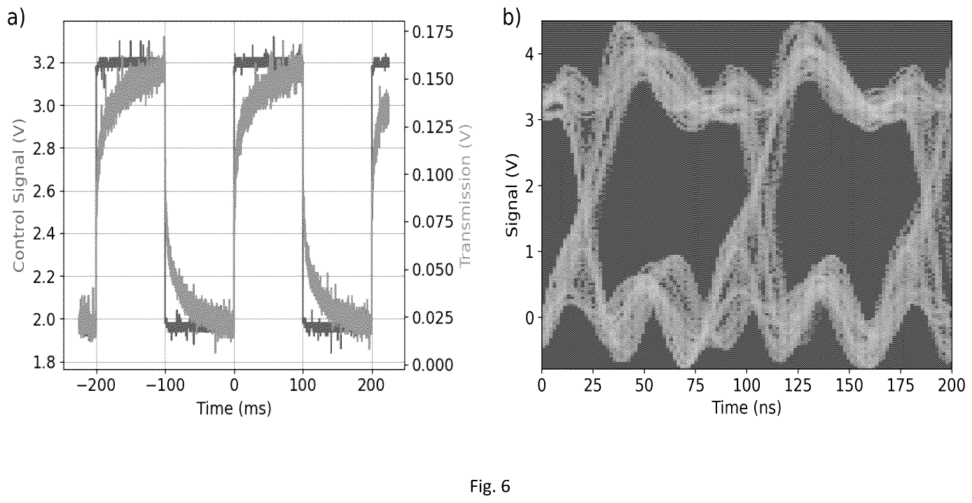

In practical terms the transmission peak tuning is 12 pm/C for thermal tuning compared to 0.20 pm/V, evidently the TO tuning range can be far larger than the EO tuning range. However, the response time of the EO effect is significantly faster. The disparity in modulation bandwidth is highlighted in FIG. 6 which shows TO modulation struggling to reproduce a 10 Hz square wave while the EO modulation achieved 12 Mbps. This test was done using the same modulator and electronics in TO or EO only mode. Similarly in FIG. 6 b) the bandwidth was limited by the electronics and not the material. The driving circuit is home-built, on a breadboard, and not properly impedance matched.

A modest EO coefficient means that small changes in voltage will have a small effect on the refractive index. This difference in orders of magnitude is leveraged for the dual-mode tuner. For example 10 mW thermal power produced through a 50Ω resistor yields a 18 pm change in transmission peak location while only producing 0.7 V across the resistor. Here we use 0.2 pm/V and 2 pm/mA for the EO and TO peak shift. The unwanted index shift from the EO part would be 0.07 pm, below 5% the TO shift. This includes a factor of 12 which accounts for how the voltage varies across the length of the electrode. The error is independent of the electrode resistance and scales with the inverse current,

$$\frac{{S}_{V}}{{S}_{T}} = \frac{V 2 \times 0.2 [ pm / V ]}{P \times 2 [ pm / mA ]} = \frac{RI 2 \times 0.2 [ pm / mA ]}{{RI}^{2} \times 2 [ pm / V ]} = \frac{1}{20 I [ mA ]} . \qquad ( 3 )$$

Where the EO shift is S_{V} and the TO shift is S_{T}.

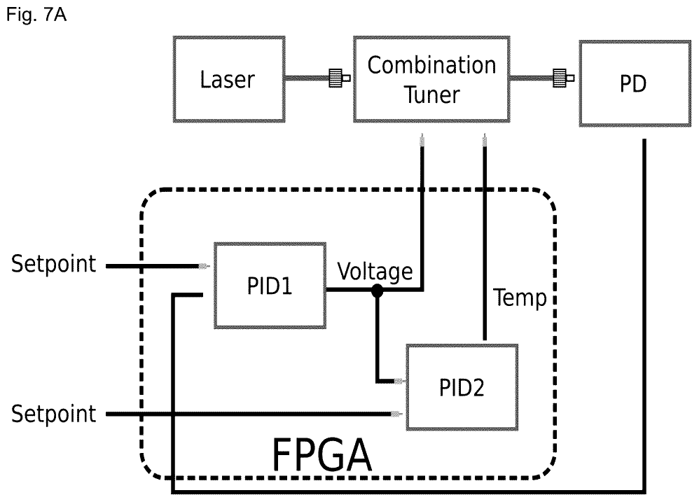

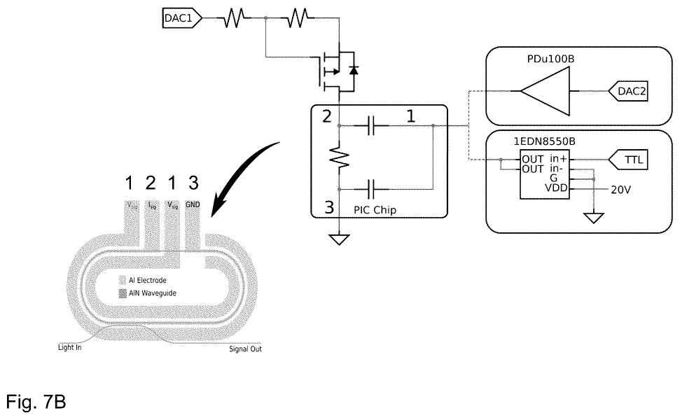

There is a lot of flexibility in this approach. Running the current through the central electrode is the most straightforward, as that electrode will have a larger resistance and is closest to the waveguide. However, it is also possible to run the current through the outer two electrodes with some design changes. It may even be possible to split the current into two halves, with each half running in opposite directions on the outer two electrodes, nullifying any EO induced change in index along the electrode. In embodiments reported herein, a straightforward approach with current running through the central electrode was used, as depicted in FIG. 7B. Other, potentially more elaborated, configurations can be used in alternate embodiments.

The dual-mode tuner circuit had two iterations for this paper, both shown in FIG. 7B, the first was optimized for EO tuning range while the second for EO switching speed. In both iterations a MTP2P50E P-type MOSFET is used to control the current flow through the electrode. The MOSFET is driven from a MCP4921 12 bit digital to analog converter (DAC) with appropriate biasing resistors to match the full scale output of the DAC, the operating current range was 10-100 mA. The photodiode voltage was read using a MAX196 analog to digital converter (ADC). PID1 can be used to correct high frequency noise and PID2 can be used to correct low frequency drift.

In the example presented in FIG. 7A, a laser is fibre coupled and sent through a micro ring resonator with the dual-mode tuner controlling the ring resonator. In this way the resonator has two electrical control ports, a current and voltage set-point, both of which are controlled by an FPGA.

In the case where maximum EO tuning range was desired the EO control circuit used a PDu100B piezo driver from PiezoDrive, which can output up to 100 V in uni-polar mode. This module has limited bandwidth, about 3 kHz, making it unsuitable for high speed modulation. In the case where fast on/off modulation was desired a 1EDN8550B gate driver was used to rapidly switch the EO voltage between 0 V and 20 V.

The digital control logic was implemented on an ICE40-HX8K FPGA with an open source toolchain: yosys for synthesis, nextpnr for routing, and icepack for conversion to bitstream.

In rugged or portable applications consistent operating conditions are not guaranteed. For this reason there has been some work developing either passively or actively stabilized modulators. In the passive case materials are carefully chosen to engineer a thermally insensitive modulator, the obvious advantage being a completely passive device. The drawback being that this type of ruggedization can only correct for thermal fluctuations and no other mechanisms which may shift the operating point of the resonator. By incorporating an active component a similar effect can be achieved at the cost of increased complexity and power draw.

In example embodiments, a dual-mode tuner is used to allow TO active stabilization of the ring resonator and EO data transmission. For data transmission the EO voltage need only be switched on and off, consequently version 2 of the circuit, which is optimized for switching speed, was used. On the FPGA a simple digital PID was constructed to feed back on the TO current with the process variable being the transmitted power. Simultaneously, the EO voltage would read out a binary word.

To measure the improvement offered by the dual-mode tuner the global temperature of the whole PIC chip was varied through adjusting the temperature of the supporting platter. At each temperature the dual-mode tuner was used to transmit a random word and the contrast between the on and off state was calculated. The same procedure was then repeated while disabling the TO loop to compare directly with an equivalent EO only modulator.

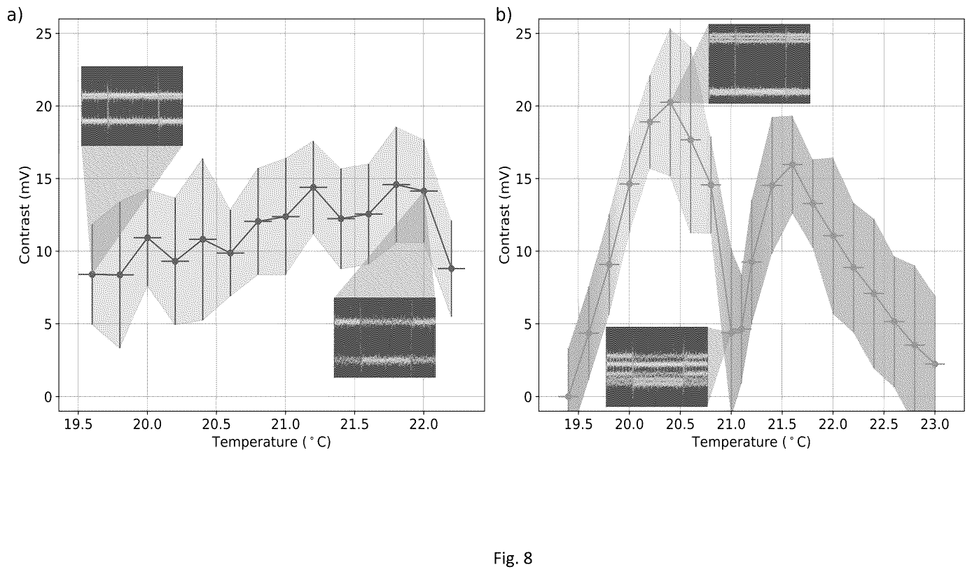

The result is succinctly shown in FIG. 8 which plots the achieved contrast for the two described cases. With the TO loop enabled the contrast remains constant over 2.6 C. Beyond this temperature change the fibre coupling of the circuit drifts leading to an un-correctable loss of power. For this reason, a laser can be used to impart thermal fluctuations. In previous tests the TO heaters have achieved a 12 C temperature change calculated from the achieved change in transmission peak location. We claim that similar performance can be expected in a dual-mode tuner if the fibres are permanently bonded as would be done when packaging such devices.

Conversely, the case where only EO modulation was used for data transmission and the TO control loop was disabled there was only 1 C region over which comparable contrast was achieved, shown in FIG. 8 b). Throughout the whole temperature sweep the contrast varied as the operating point shifted across the transmission peak. There are two points of maximum contrast, one on either side of the transmission peak, however only one side will transmit the data faithfully the other will bit-flip the data.

In conclusion the dual-mode tuner has shown a 2.6× improvement in operating temperature range over a simple EO modulator. With proper packaging there is no reason that the operating range could not extend to 12 C. Furthermore the improvement would only be amplified with higher quality factor ring resonators.

Another typical application for micro-ring resonators is as a source of frequency selective feedback for hybrid ECDLs. In these applications the frequency of the laser is determined by the state of the micro-ring resonator and can be frequency locked by controlling feedback on the resonator state.

In both cases the modulator state is modified in response to a measured variable, in this paper we use a simple toy model to investigate the modulator in isolation by stabilizing the transmission intensity of the modulator. The basic configuration is laser light sent through a micro-ring modulator and the transmitted light monitored on a photodiode. The dual-mode tuner is used to control the TO current and EO voltage, as shown in FIG. 7A. Error is injected into the system through global temperature variation or mechanical disturbance.

The benefit of a dual-mode tuner in this use case is to counteract the drawbacks of limited tuning range for the EO modulator and the limited response time for the TO modulator. Because the desired response from the dual-mode tuner is continuous for this example circuit 2 is used. A split control loop was implemented to make full use of both types of tuning, shown in FIG. 7A, where two PID loops run simultaneously. The TO current loop seeks to bring the EO voltage to its half full scale value, while the EO voltage seeks to maintain the transmission intensity at the set-point.

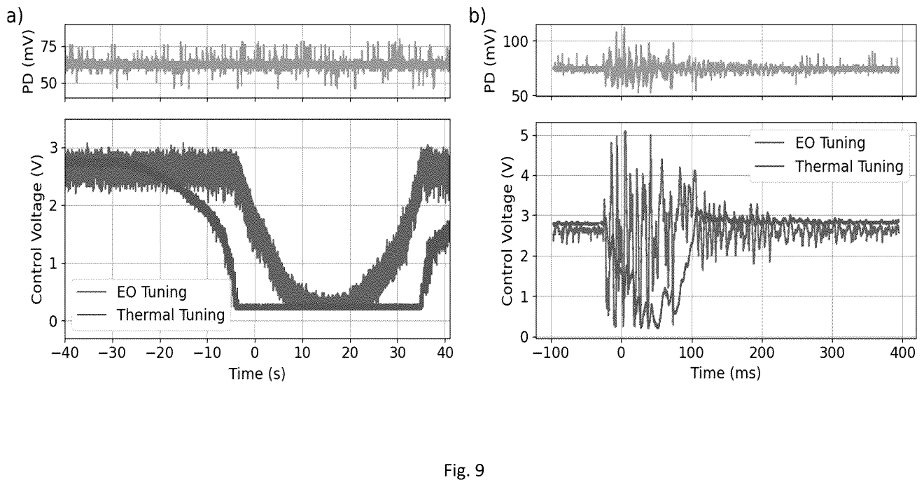

First the locking range was tested by changing the global temperature of the chip. This was a slow change which was initially corrected for entirely by the TO loop. However when the limits of the TO loop were reached the EO tuning range was also utilized to extend the tuning range and correct for 3 C change in plate temperature as shown in FIG. 9 a). The global temperature controller displays considerable overshoot when changing the temperature leading to a temporary period where both EO and TO are required to correct for the disturbance, after which TO alone is sufficient.

Beyond the slow change in ambient climate conditions, mechanical vibrations in the kHz timescale are the next concern. To simulate this type of disturbance the cantilevered testing station was tapped on inducing a kHz ringing. In this case the TO tuner is not sufficiently fast to correct for the error, instead the EO voltage is primarily used to minimize the error. Having a TO knob continues to be of benefit though, as the TO current continues to remove the low frequency error components leaving more gain at the higher frequencies for the EO loop. This is shown clearly in FIG. 9 b) where the TO current responds to the disturbance but is not able to follow the fast oscillating part, the EO voltage does follow the fast part and greatly reduces the measured error.

We have presented a dual-mode tuner which can alleviate a pain point of using aluminum nitride as a photonic integrated circuit material, namely choosing between fast modulation through the EO effect or large tuning range through the TO effect. The dual-mode tuner was shown to maintain the desirable qualities of both types of tuning without increasing the number of nanofabrication steps. Two sample circuits were presented for the two sample applications: data transfer subject to climate fluctuations and stabilizing the transmission intensity of a ring resonator. In both cases the use of a dual-mode tuner improved the performance over using only TO or EO modulation. Solutions such as this one may pave the way for more complex PIC devices in AlN.

As can be understood, the examples described above and illustrated are intended to be exemplary only. Indeed, beyond example embodiments reported herein, the dual-mode phase tuner can be implemented in a wide range of photonic integrated systems. These include, but are not limited to, tunable optical filters, Mach-Zehnder interferometers, wavelength-selective switches, frequency-modulated continuous-wave (FMCW) LiDAR transmitters, tunable cavity and external-cavity diode lasers, optical frequency combs, and active quantum photonic circuits requiring high-speed phase stabilization or feedback control. In these embodiments, the integrated electro-optic and thermo-optic tuning within a single nanofabrication layer provides a versatile approach to achieve both high modulation bandwidth and large tuning range across diverse photonic platforms. The scope is indicated by the appended claims.

What is claimed is:

1. A photonic integrated circuit (PIC) device comprising:
a PIC chip having one or more superposed layers including a tuning circuit layer,
the one or more superposed layers including a waveguide for electromagnetic radiation, the waveguide being made of non-centrosymmetric crystalline material having a non-zero Pockels coefficient, and
the tuning circuit layer having an electrical circuit including a resistance thermally coupled to the waveguide, and an electrode capacitively coupled to the waveguide;
a current source connected to the resistance;
a voltage source connected to the electrode; and
a controller operable to
control the current source in a manner to perform thermo-optic phase tuning to the waveguide via variations in resistive heating of the resistance, and
control the voltage source in a manner to perform electro-optic phase tuning to the waveguide via variations in electric field generated at the electrode and a Pockels effect associated to the non-zero Pockels coefficient.

2. The PIC device of claim 1 wherein the waveguide is made of aluminum nitride (AlN).

3. The PIC device of claim 2 wherein the waveguide is integrated to one of the one or more superposed layers which is distinct from the tuning circuit layer and has an electro-optically active crystal axis oriented normal to the superposed layers, the resistance is in the form of an elongated conductor which is aligned with the waveguide and disposed above the waveguide, and the electrode includes two elongated conductors disposed alongside the resistor on opposite sides thereof.

4. The PIC device of claim 2 wherein the waveguide is integrated to the tuning circuit layer and has an electro-optically active crystal axis oriented parallel to the superposed layers, the resistance is in the form of an elongated conductor which is disposed alongside the waveguide, and the electrode includes an elongated conductor disposed alongside the waveguide, opposite the resistance.

5. The PIC device of claim 2 wherein the electromagnetic radiation is in one or more of an infrared, visible and a UV range of electromagnetic radiation.

6. The PIC device of claim 1 wherein the waveguide is made of lithium niobate (LiNbO3).

7. The PIC device of claim 1 wherein the waveguide is made of scandium-doped aluminum nitride (Al(Sc)N).

8. The PIC device of claim 6 wherein the waveguide is integrated to the tuning circuit layer and has an electro-optically active crystal axis oriented parallel to the superposed layers, the resistance is in the form of an elongated conductor which is disposed alongside the waveguide, and the electrode includes an elongated conductor disposed alongside the waveguide, opposite the resistance.

9. The PIC device of claim 6 wherein the electromagnetic radiation is in one of an infrared and a visible range of electromagnetic radiation.

10. The PIC device of claim 1 wherein the Pockels coefficient is of at least 0.06 Picometers per volt.

11. The PIC device of claim 10 wherein the Pockels coefficient is of at least 0.6 Picometers per volt.

12. A method of operating a photonic integrated circuit (PIC) device including:
propagating electromagnetic radiation in a waveguide made of a non-centrosymmetric crystalline material having a non-zero Pockels coefficient along an electro-optically active crystal axis;
controlling the phase of the electromagnetic radiation including:
circulating a current through a resistance which is thermally coupled to the waveguide, and
applying an electrical field at the waveguide, along the electro-optically active crystal axis.

13. The method of claim 12 wherein said circulating and applying are performed one after the other.

14. The method of claim 12 wherein said circulating and applying are performed simultaneously.

15. The method of claim 12 wherein the electromagnetic radiation is in a visible range.

16. A photonics integrated circuit (PIC) chip comprising:
one or more superposed layers including
a waveguide for electromagnetic radiation, the waveguide being made of non-centrosymmetric crystalline material having a non-zero Pockels coefficient; and
a tuning circuit layer having an electrical circuit including a resistance thermally coupled to the waveguide, and an electrode capacitively coupled to the waveguide.

17. The PIC chip of claim 16 wherein the waveguide is made of aluminum nitride (AlN).

18. The PIC chip of claim 17 wherein the waveguide is integrated to one of the one or more superposed layers which is distinct from the tuning circuit layer and has an electro-optically active crystal axis oriented normal to the superposed layers, the resistance is in the form of an elongated conductor which is aligned with the waveguide and disposed above the waveguide, and the electrode includes two elongated conductors disposed alongside the resistor on opposite sides thereof.

19. The PIC chip of claim 17 wherein the waveguide is integrated to the tuning circuit layer and has an electro-optically active crystal axis oriented parallel to the superposed layers, the resistance is in the form of an elongated conductor which is disposed alongside the waveguide, and the electrode includes an elongated conductor disposed alongside the waveguide, opposite the resistance.

20. The PIC chip of claim 16 wherein the waveguide is made of lithium niobate (LiNbO3).
